(19) United States
(12) Patent Application Publication
(10) Pub. No.: US 2003/0205624 A1
(43) Pub. Date: Nov. 6, 2003

(54) Differentiable card and fabrication method thereof

(76) Inventors: Chih-Yang Huang, Taoyuan Hsien (TW); Tsung-Chao Li, Chung-Li City (TW); Wen-Liang Yeh, Hsin Chu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/136,300

(22) Filed: May 2, 2002

(51) Int. Cl. G06K 19/06

(52) U.S. Cl. 235/494

(57) ABSTRACT

A card fabrication method of the invention uses ABS plastics to form a card body of the card. The fabrication method of the invention is used to manufacture various types of cards such as bankcards. The ABS material is injection molded to form the card body. While injection molding the card body, different additives and colorant agents are incorporated to the ABS to obtain a card body that is easily differentiated via a specific color aspect. The specific color aspect is in accordance with a specific card emitter. Printing is simultaneously performed on two faces of the card body to achieve the differentiable card. By attributing specific color aspects to specific card emitters and, counterfeit cards is therefore easily differentiated from authentic cards by the color aspect of the card body.

### BACKGROUND OF THE INVENTION

1. Field of the Invention

The invention relates to a card fabrication method. More particularly, the invention provides a card fabrication method that enables to obtain a card body with a specific color aspect attributed to a specific card emitter, thereby allowing the user to easily differentiate a counterfeit card from an authentic card.

2. Description of the Related Art

The utilization of card elements is nowadays very common such as bankcards, credit cards, or specific commemoration cards. For example, the use of bankcards is extremely convenient for the consumers to purchase, or withdraw cash money. However, as bankcard utilization becomes popular, counterfeit cards are also increasingly disseminated, which causes economic damages to both card emitters and card users.

Presently, most of the cards used by the consumers principally consist of white-colored bodies. With this uniform card body color, it is difficult for the user to differentiate the counterfeit card from the authentic and valid card. A current remedy to this problem is the use of specific equipment to discriminate the authentic and valid card from the counterfeit card. However, this solution is not satisfactory because it requires the consumer to be provided with the adequate equipment, which is cumbersome to achieve.

Referring to FIG. 1, a flow chart schematically shows a conventional card fabrication method. Card manufacturers conventionally use PVC (polyvinyl chloride) plastics as basic substrate. After surface printing of different patterns is completed on the substrate, pressing, cutting, and stamping processes are performed to achieve the final card used by the consumer.

The above fabrication method has at least the following inconveniences. First, the fabrication method requires an excessive number of process steps that need an excessive amount of labor cost and is further time consuming.

Moreover, because the card is fabricated via pressing, careless manipulation of the operator may cause a deviation of the two opposite faces of the card. Furthermore, because the achieved card has a card body that is uniformly white, the user therefore cannot differentiate counterfeit card from authentic and valid card. A prevention of card dissemination is further difficult to achieve because the traditional fabrication method as described above usually requires external subcontractors.

Ultimately, the traditional card is fabricated from PVC material that, when subjected to decomposition reaction, generates toxic gases, which therefore does not meet the standards of environmental protection.

### SUMMARY OF THE INVENTION

It is therefore a first object of the invention to provide a differentiable card and a method thereof that allow the user to easily differentiate the counterfeit card from the authentic card via a color aspect of the card body.

It is another object of the invention to provide a differentiable card that uses a recyclable material which does not pollute the environment.

To accomplish the above and other objectives, a card fabrication method of the invention uses ABS plastics to form a card body of the card. The ABS material is injection molded to form the card body. While injection molding the card body, different additives and colorant agents are incorporated to the ABS to obtain a card body that is easily differentiated via a specific color aspect. The specific color aspect is in accordance with a specific card emitter. Printing then is simultaneously performed on two faces of the card body to achieve the differentiable card.

By attributing specific color aspects to specific card emitters and, counterfeit cards are therefore easily differentiated from authentic cards by the color aspect of the card body. Furthermore, by limiting the amount of cards fabricated, potential counterfeit card dissemination can be limited.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a flow chart of a conventional card fabrication method; and

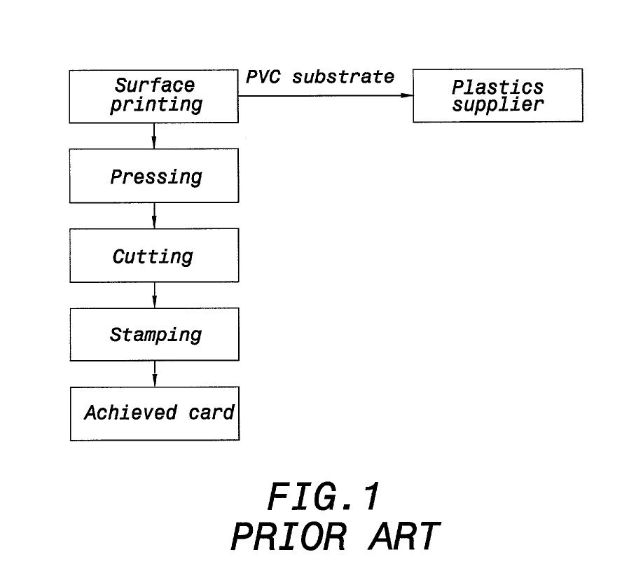

FIG. 2 is a flow chart of a fabrication method of differentiable cards according to an embodiment of the invention.

### DETAILED DESCRIPTION OF THE EMBODIMENTS

Wherever possible in the following description, like reference numerals will refer to like elements and parts unless otherwise illustrated.

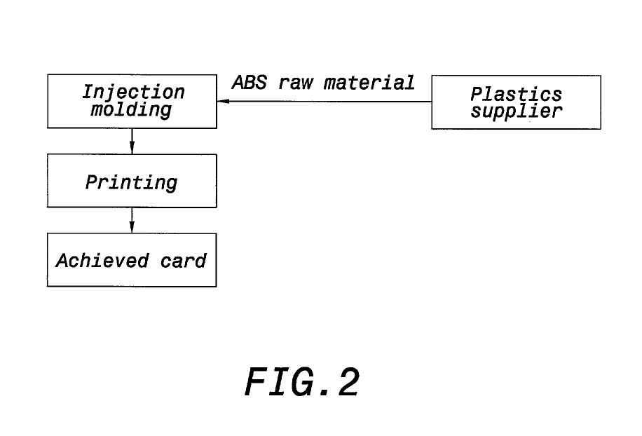

Referring to FIG.2, the invention provides a differentiable card and its fabrication method. The fabrication method of the invention can be implemented to manufacture differentiable cards such as bankcards, credit cards or other specific commemoration cards.

The fabrication method of the invention uses ABS (Acrylonitrile Butadiene Styrene) plastics as raw material to fabricate a differentiable card. ABS material used in the invention is recyclable, and can be further processed in accordance with environmental protection standard.

In a first step, while ABS is injection molded for forming a card body, different additives and different colorant agents are uniformly incorporated to the ABS. As a result, the card body formed is provided with a differentiable color aspect.

Via a printing machine, printing then is simultaneously performed on the two opposite sides of the card body. After printing is completed on the card body, a differentiable card hence is achieved.

Depending on the demand, a magnetic strip or a protection film may be further attached onto the differentiable card body.

With the fabrication method as described above, the processing steps are favorably reduced to strictly include injection molding and printing steps to achieve the differentiable card body. The differentiable card body can be therefore fabricated in a single fabrication site without the need of external subcontractors. Card dissemination during the fabrication process is therefore prevented. As a result, counterfeit cards can be favorably limited and reduced.

Via a unique printing step simultaneously performed on the two faces of the card, the fabricated card body can satisfy the required demand of precision.

Furthermore, by the addition of different additives and different colorant agents while injection molding is performed, the card body can be formed with differentiable color aspects. The conventional use of pressing method fails to achieve the above advantageous results.

In contrast with conventional uniformly white-colored cards, the specifically colored card body of the invention therefore allows the user to easily differentiate a counterfeit card from an authentic and valid card, specific color aspects being attributed to specific card emitters. The distinction between counterfeit and authentic cards can be further enhanced via limiting the combination of specific colors used to fabricate the card body. Economic damages of both users and card emitters can be thereby limited and reduced.

Moreover, by using ABS plastics as raw material, the fabrication method of the invention meets the requirements of environmental protection.

In conclusion, the invention provides a fabrication method that can manufacture card bodies easily differentiable by their specific colors. The fabrication method of the invention is achieved in a single fabrication site, which limits the dissemination of cards during the fabrication process. To fabricate the differentiable cards, the invention further uses injection molding and printing processes that require a heavy investment of equipment. As a result, the fabrication of counterfeit cards can be favorably limited and reduced.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A fabrication method of differentiable cards, comprising:
injection molding a raw material into a card body;
adding different additives or colorant agents while injection molding the card body so as to obtain a card body differentiable via a color aspect thereof; and
performing a printing process simultaneously on two faces of the card body, wherein the specific color aspect of the card body is attributed to a specific card emitter.

2. The method of claim 1, wherein the raw material is Acrylonitrile Butadiene Styrene plastics.

3. A differentiable card comprising a card body having a specific color aspect for corresponding to a specific card emitter of the differentiable card, wherein the differentiable card is differentiated from a counterfeit card via the specific color aspect thereof.
